(19) United States
(12) Patent Application Publication
(10) Pub. No.: US 2013/0020137 A1
(43) Pub. Date: Jan. 24, 2013

(54) Hall Cell Load Measuring Device for Lift Trucks

(71) Applicants: Steven Gauthier, Inverness, IL (US); Anthony Parakka, Rockford, IL (US); Aaron Kaplan, Evanston, IL (US); Benjamin C. Plamp, Chicago, IL (US)

(72) Inventors: Steven Gauthier, Inverness, IL (US); Anthony Parakka, Rockford, IL (US); Aaron Kaplan, Evanston, IL (US); Benjamin C. Plamp, Chicago, IL (US)

(21) Appl. No.: 13/464,095

(22) Filed: May 4, 2012

Related U.S. Application Data
(60) Provisional application No. 61/508,785, filed on Jul. 18, 2011.

(51) Int. Cl. G01G 19/12; G01G 7/02

(52) U.S. Cl. 177/136; 177/210 EM

(57) ABSTRACT

A weight measuring device includes a first link coupled to one end of a load to be measured. A second link is coupled to another end of a load to be measured. The first and second links include respective sections of a housing configured to place a spring in increasing compression with respect to increasing load on the first and second links. A hall cell and magnet are coupled between the first and second links to enable relative movement therebetween. The hall cell generates a signal related to an amount of movement of the first link with respect to the second link.

### CROSS-REFERENCE TO RELATED APPLICATIONS

Priority is claimed from U.S. Provisional Application No. 61/508,785 filed on Jul. 18, 2011 and incorporated herein by reference in its entirety.

### STATEMENT REGARDING FEDERALLY SPONSORED RESEARCH OR DEVELOPMENT

Not applicable.

### BACKGROUND

The disclosure relates generally to the field of lift trucks (forklifts). More specifically, the disclosure relates to devices for weighing the load being moved or lifted on such lift trucks.

The state of the art for lift truck weight sensing includes two general technologies. One of these general technologies is weighing systems that mount where the original forks would mount on the truck. An example of such system is shown in FIG. 1A wherein the mounting studs for the fork plate may include Wheatstone bridge or similar strain gauge load cells, e.g., at 4A. These systems are very accurate but may be expensive.

The other general technology is hydraulic pressure sensors that measure the pressure of the hydraulic fluid in the hydraulic system that is applying force to lift the forks. These sensors are inexpensive (<$100), but they are not very accurate; their performance may degrade rapidly over time as the hydraulic systems wears and loses efficiency, and the forks must be in motion (moving up or down) for the sensors to work.

What is needed is an improved weight sensor for lift trucks.

### SUMMARY

One aspect of the disclosure is a weight measuring device including a first link coupled to one end of a load to be measured. A second link is coupled to another end of a load to be measured. The first and second links include a housing configured to place a spring in increasing compression with respect to increasing load. The weight measuring device includes a hall cell and magnet coupled between the first and second links. The hall cell generates a signal related to the amount of movement of the first link with respect to the second link.

Other aspects and advantages of the devices disclosed herein will be apparent from the description and claims which follow.

### BRIEF DESCRIPTION OF THE DRAWINGS

FIG. 1A is an example prior art weight measuring device.

FIGS. 1 through 5 show various views of a load measuring device according to the invention.

FIG. 6 illustrates an example forklift to show chains where example weight measuring devices may be mounted.

### DETAILED DESCRIPTION

FIG. 6 shows an example lift truck (forklift) at 30. As explained in the Background section herein, the lift truck 30 may include a fork frame 34 sliably suspended on rails 35. The fork frame 34 may include two forks 32 extending therefrom to underlie and lift a selected load. The fork frame 34, and thus the forks 32, may be raised and lowered by chains 36. The chains may be spooled by a chain winch (not shown) to extend and retract the chains.

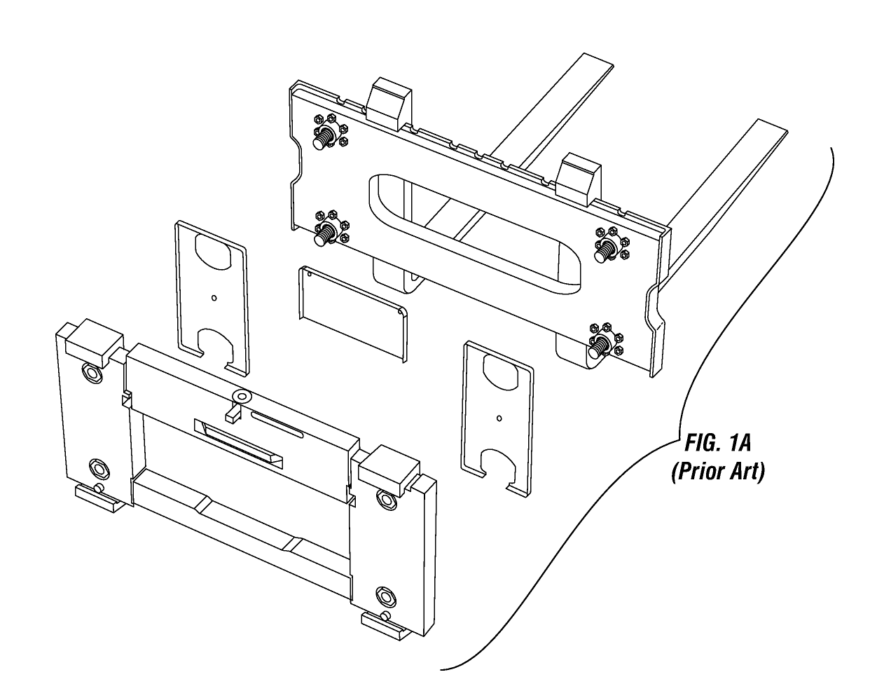

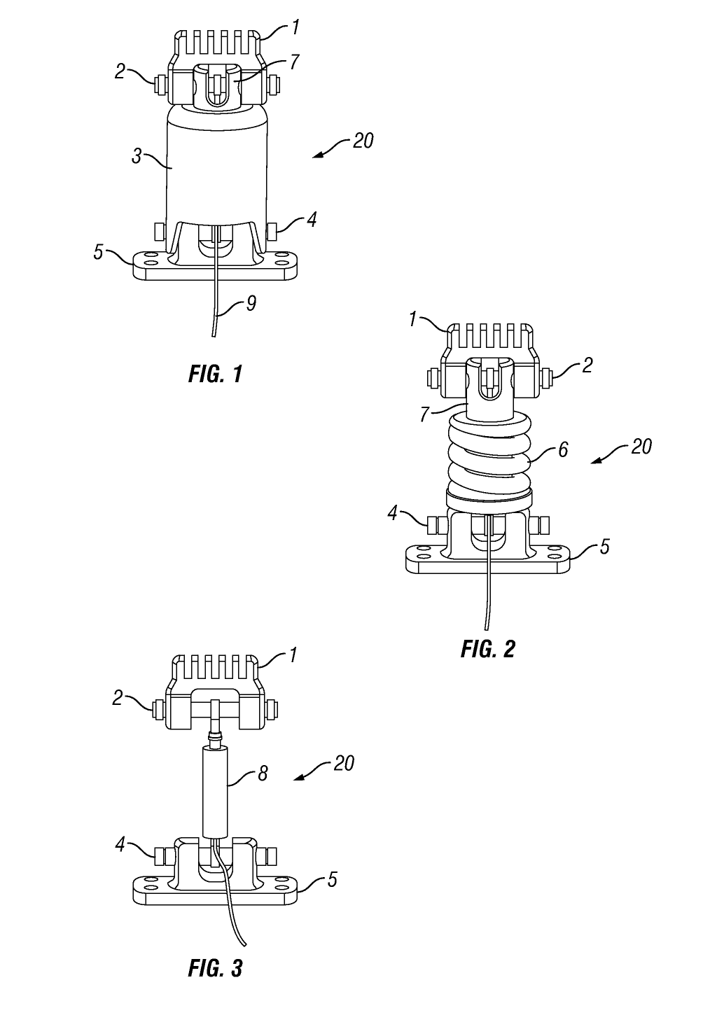

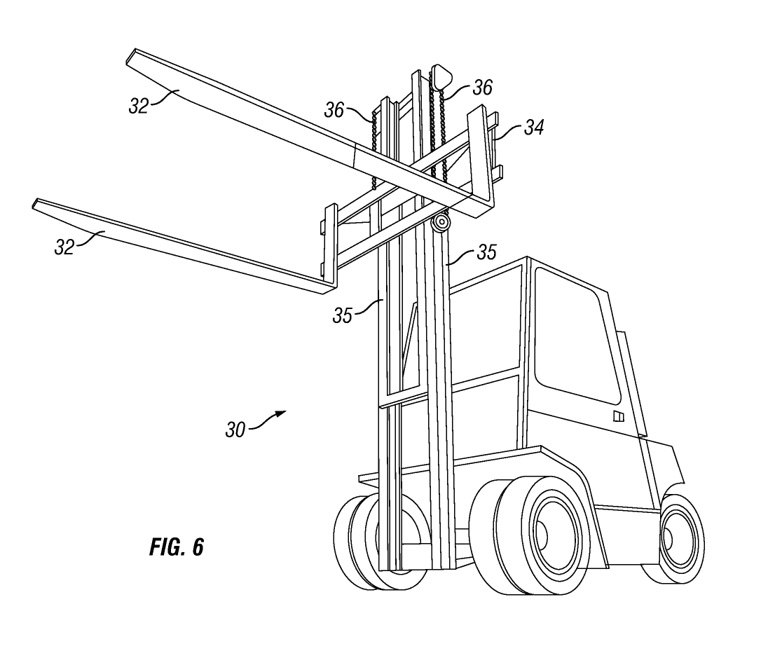

Referring to FIGS. 1 through 5, in operation a weight sensor 20 shown in the drawings may be mounted within in a lift truck chain (e.g., 32 in FIG, 6), either connected to the chain at both ends of the sensor, or connected to the chain at one end and rigidly mounted to a truck frame, e.g., the fork frame (34 in FIG. 6) at the other, as depicted in the drawings. Irrespective of the mounting type used the example sensor operation is the same.

Tension in the chain resulting from the weight on the lift truck forks may be transferred to an upper link 1 The upper link 1 transfers the tension to an upper link pin 2. The upper link pin 2 transfers the tension to an inner support 7. The inner support 7 transfers the tension to a spring 6, at the end of the spring near a lower link 5.

The spring 6 transfers the tension to an outer support and housing 3, in the present example at the top of the outer support and housing 3. The outer support housing 3 may transfer the tension to a lower link pin 4. The lower link pin 4 may transfer the tension to the lower link 5.

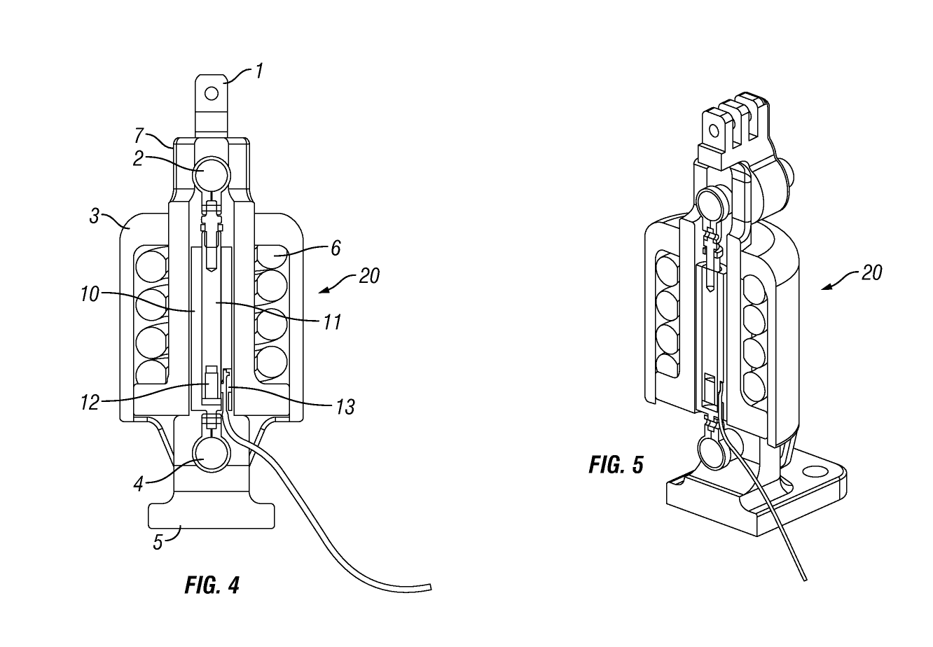

In the example configuration shown, when tension is transferred to the spring 6 at the opposite ends of the spring 6 from which the tension enters the sensor 20, the spring 6 is placed under increasing compression as the tension increases. Tension increase in a chain lifted fork frame may be related to the amount of weight load on the forks and thus the form frame (FIG. 6) As the spring 6 compresses, there may be relative linear motion between a stator and hall cell (10 in FIG. 4) which may be attached to the lower link 5, and an armature and magnet (11 in FIG. 4) which may be attached to the upper link 1. The magnet 11 may be made, for example, from any suitable permanent magnet material. Relative motion between the Hall cell 10 and the magnet 11 may produce an output signal that is proportional to the compression of the spring 6. The spring compression may be proportional to the tension in the chain, which is a measure of the weight on the forks of the lift truck.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A weight measuring sensor, comprising:
a first link coupled to one end of a load to be measured
a second link coupled to another end of a load to be measured
the first and second links including respective sections of a housing configured to place a spring in increasing compression with respect to increasing load on the first and second links; and
a hall cell and magnet coupled between the first and second links to enable relative movement therebetween, the hall cell generating a signal related to an amount of movement of the first link with respect to the second link.

2. The weight measuring sensor of claim 1 wherein the first link and the second link are coupled to respective portions of a lift chain in a lift truck.

3. The weight measuring sensor of claim 1 wherein the first link is coupled to an end of a lift chain in a lift truck and the second link is coupled to at least one of a truck frame and a fork frame in the lift truck.
